(19) United States
(12) Patent Application Publication
(10) Pub. No.: US 2017/0269317 A1
(43) Pub. Date: Sep. 21, 2017

(54) Slim Line Tactical Fiber Optic Cable

(71) Applicants: Frank Giotto, (US); Alexander Pushchin, (US); Lawrence Gerald Traver, Sr., (US)

(72) Inventors: Frank Giotto, New Hartford, NY (US); Alexander Pushchin, Schoharie, NY (US); Lawrence Gerald Traver, SR., Canastota, NY (US)

(21) Appl. No.: 15/016,836

(22) Filed: Feb. 5, 2016

(51) Int. Cl. G02B 6/44; B29C 47/00

(52) U.S. Cl. CPC G02B 6/443; B29C 47/0014; B29L 2011/0075

(57) ABSTRACT

The invention relates to a fiber optic cable for information transmission, comprised of multiple buffered optical fibers surrounded by aramid yarn within a thermoplastic jacket, produced using a TPE Hytrel buffer, manufactured using a pressure tooling extrusion process. This Hytrel buffering allows for the production of a cable that has a one-third smaller diameter compared to standard PVC buffered distribution cable. Despite this smaller diameter, this invention surpasses the standard PVC buffered distribution cable in both Compressive Load and Impact Testing, and meets Mil-Spec standards.

### FIELD OF THE INVENTION

The present invention relates generally to the field of fiber optic cables and, more particularly, to a fiber optic cable produced by a buffering process that allows for a smaller diameter cable with durable characteristics, surpassing the standard PVC buffered distribution cable in both Compressive Load and Impact Testing, while also meeting Mil-Spec Standards for that particular cable diameter.

### BACKGROUND OF THE INVENTION

The fiber optic cable allows for the transmission of various data forms by use of light. The standard optical fiber consists of various layers, including the optical fiber or fibers, a strength layer, and a protective cover completing the cable.

Fiber optic cables can be used in rugged environments, and it is often desirable that these cables be as compact as possible for the ease of transportation and installation. As the size of the cable diameter decreases, more cable will fit on a spool and thereby can be more easily transported and installed in restricted locations. A cable with a smaller diameter still must retain certain physical and optical characteristics in order to be an effective means of information transmission. Fiber optic cable tests include compressive load and sudden impact, while measuring the loss in light transmission. Fiber optic cable diameters typically increase as the fibers with required protection are added to enable the cables to withstand these tests. The standard PVC buffered 12 fiber distribution cable ranges from approximately 6.9 mm to 7.5 mm. This is dependent upon the manufacturer and the strength members used. It would be advantageous to make a smaller diameter cable that can withstand similar or better compressive load and impact tests, allowing an increase in the length of cable stored on a spool and easier installation. This new invention would allow for the accommodation of special user requirements in a diverse array of fields and environments.

Therefore, there is a need in the fiber optic cable industry to produce a slimmer cable that holds up to compressive load and impact testing, producing equal or superior results when compared to the standard PVC fiber optic cable.

### BRIEF SUMMARY OF THE INVENTION

In accordance with the present invention, there is provided . . . a Slim Line Tactical Cable with a nominal diameter of 5.1 millimeters (mm) that withstands compressive load and impact testing better than standard PVC buffered cable with a diameter of 7 millimeters (mm). The diameter of the Slim Line Tactical Cable, at 5.1 millimeters, is ⅓ smaller than the standard PVC buffered cable, ranging from 6.9 mm to 7.5 mm. Since this Slim Line Tactical Cable is smaller in diameter, this present invention equates to having the ability to place ⅓ more meters of cable on each spool. This is especially important in regards to deploying and shipping the spools, leading to decreased shipping costs. This invention provides the end user a more rugged cable, yet reducing its size and weight.

It would be advantageous to provide . . . fiber optic cable with a smaller diameter that performs as well as or better in certain tests when compared to the standard PVC buffered distribution cable.

It would also be advantageous to provide . . . a fiber optic cable with a reduced size buffer, 400 micron (um) to 750 micron (um) diameter, using a Hytrel (Thermoplastic Polyester Elastomer—TPE) coating.

It would also be advantageous to provide . . . a smaller diameter distribution style cable with fiber counts ranging from 6-24.

It would further be advantageous to provide . . . a fiber optic cable with diameters up to one third smaller than a standard PVC buffered fiber optic cable.

It would also be advantageous to provide . . . a fiber optic cable with a smaller diameter that still meets Mil Spec standards required for that smaller diameter size.

It would be further advantageous to provide . . . a fiber optic cable whose smaller diameter allows for the cable to be transported on smaller spools, saving cost on the spools themselves, and also on shipping and storage costs.

### BRIEF DESCRIPTION OF THE SEVERAL VIEWS OF THE DRAWING

A complete understanding of the present invention may be obtained by reference to the accompanying drawings, when considered in conjunction with the subsequent, detailed description, in which:

### DETAILED DESCRIPTION OF THE PRESENT INVENTION

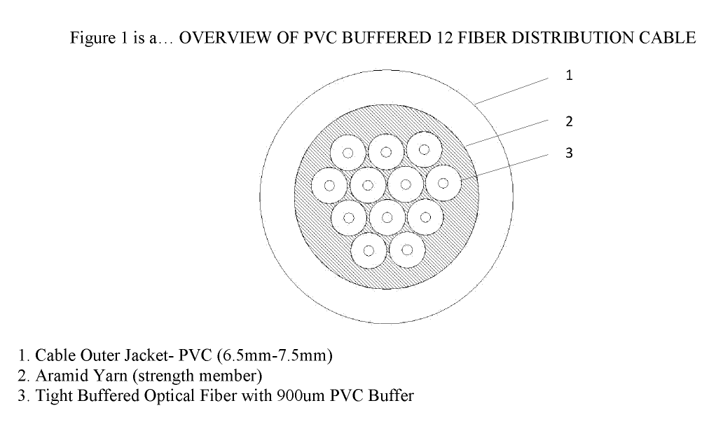

A typical backbone cable utilizing an industry standard 900 um PVC buffer may be seen in FIG. 1. This type of cable would be tested for a Riser or Plenum flame rating (OFNR/OFNR). Such a cable utilizes minimal aramid yarn, as required for pulling and strain relief.

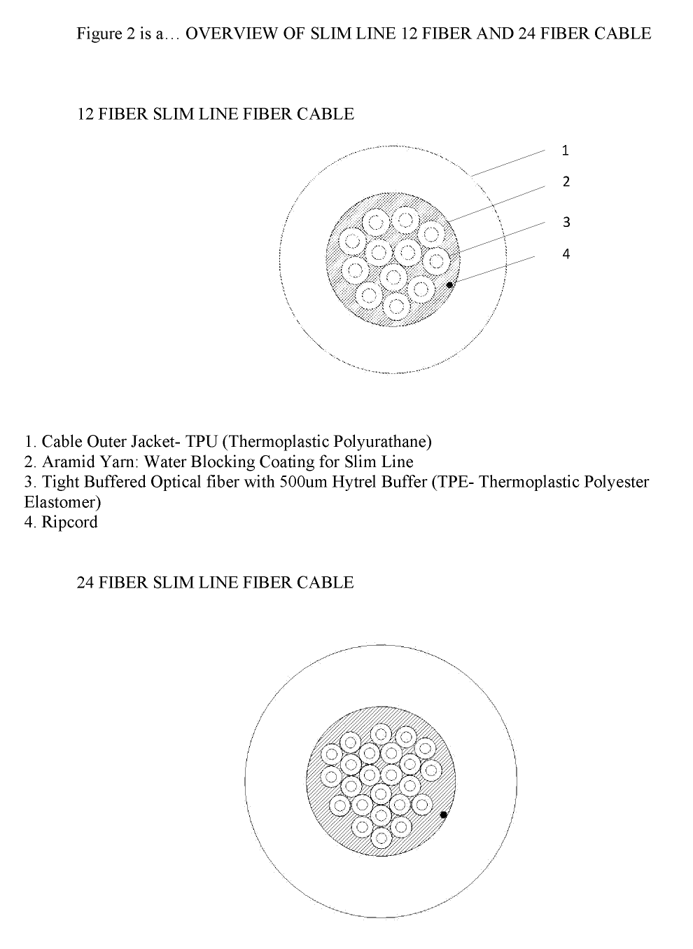

Two examples (12 and 24 fiber) of the Slim Line Tactical Fiber Optic Cable can be seen in FIG. 2. This cable utilizes an abundant amount of water blocking aramid yarn for pulling and to provide complete coverage of the Hytrel buffers to avoid interference between the Hytrel buffers and the TPU jacket during the extrusion process.

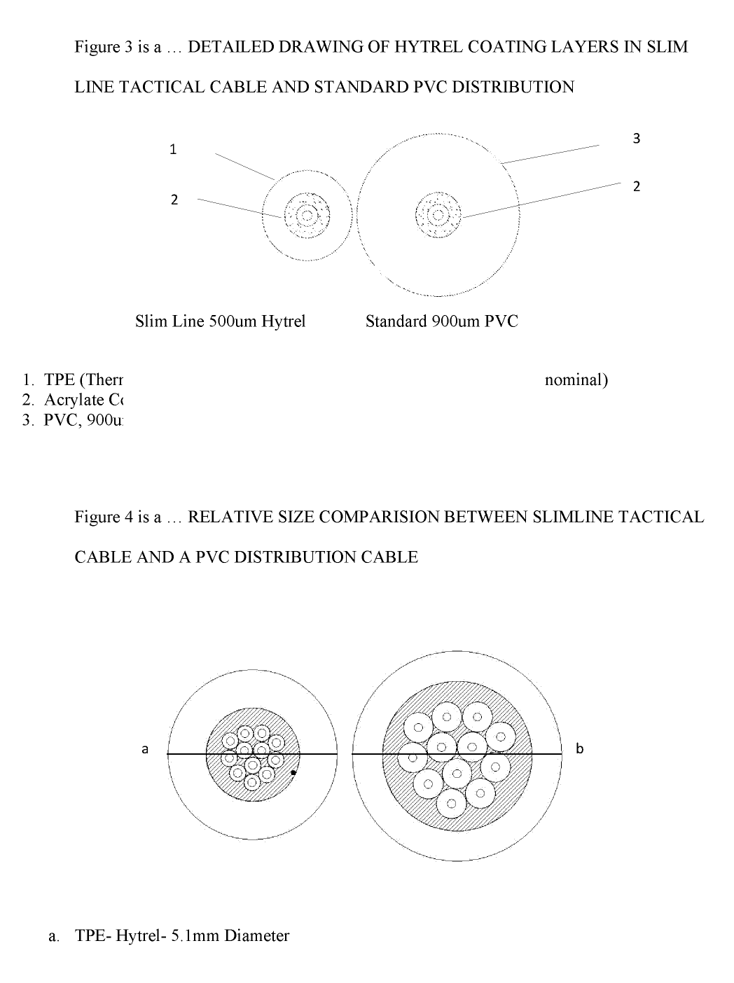

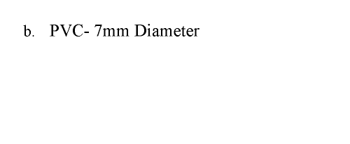

The ability to reduce the outer dimension of the buffer can be seen by the size difference between the small 500 um Hytrel and larger 900 um PVC buffered optical fiber observed in FIG. 3. FIG. 4 also details the relative size comparison of the 500 um Hytrel and the 900 um PVC.

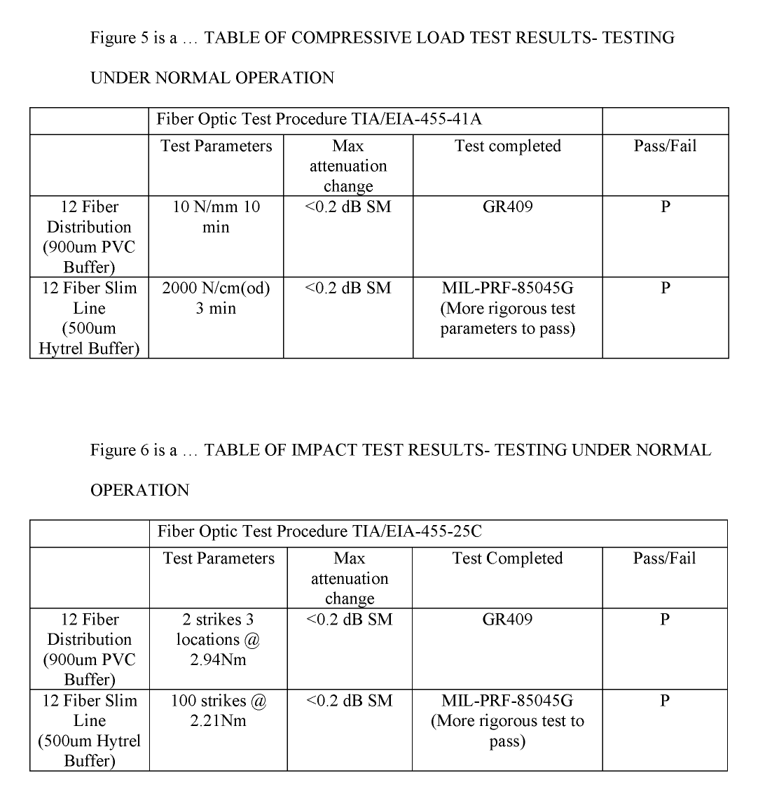

FIGS. 5 and 6 show the different impact and compressive load test parameters performed on the two 12 fiber cable constructions. The tables display that the 12 fiber Slim Line 500 um outperforms the 12 fiber distribution 900 um PVC in both tests. The ability of the 12 fiber Slim Line 500 um fiber cable to undergo more stringent testing while at a smaller dimension is due to the effective use of the Hytrel coating which has a higher hardness than those typical PVC compounds regularly used in fiber optic cables.

Both FIGS. 5 and 6 demonstrate testing results under normal operation. The 12 fiber Slim Line 500 um Hytrel cable vastly outperforms the 12 fiber distribution 900 um PVC cable in both Compressive Load and Impact Testing. The 12 fiber Slim Line 500 um cable passes the more rigorous Mil Spec test MIL-PRF-85045G. This is in comparison to the less rigorous test which the 900 um PVC is tested against, GR409. The 12 fiber Slim Line 500 um cable can withstand 2000 N/cm for 3 minutes under the Compressive Load Test, while the 12 fiber distribution 900 um PVC only needs to withstand 10 N/mm for 10 minutes. In Impact Testing, the 12 fiber Slim Line 500 um withstands 100 strikes at 2.21 Nm, while the 12 fiber distribution 900 um PVC only passes the test for 2 strikes at 3 different locations at 2.94 Nm.

What is claimed is:

1. A Slim Line Tactical Fiber Optic Cable that is formed using a special process and Hytrel coating, Hytrel Thermoplastic Polyester Elastomer (TPE) that is commercially available from DuPont. The use of a TPE allows for a thinner buffer coating than typical polyvinylchloride (PVC) resulting in an overall smaller diameter cable. The TPE is a harder material than PVC. Utilizing this stronger material in turn allows for a thinner coating while providing superior protection of the fiber. This allows for an approximately one third smaller diameter cable that surpasses standard PVC buffered distribution cable in the industry accepted detailed specification, Telcordia GR409-CORE for Compressive Load Test and Impact Test. The invention has been tested, and meets, Military Specifications (Mil-Spec) required for ground tactical fiber optic cable, comprising:

2. A Slim Line Tactical Fiber Optic Cable in claim 1, that is 5.1 millimeters in diameter, producing Compressive Load test results with the ability to hold 2000 N/cm(od) for three minutes. This equates to about 880 lbs using the standard test anvil dimensions of the TIA-455-41 test standard. These test results are superior to a standard PVC buffered distribution cable which produced Compressive Load test results of the ability to hold 10 N/mm for 10 minutes for a similar apparatus loading of 200 lbs.

3. A Slim Line Tactical Fiber Optic Cable in claim 1, which is 5.1 millimeters in diameter, withstanding 2.21 Nm of energy for 100 strikes in a single location. These test results are superior to a standard PVC buffered distribution cable which withstood 2.94 Nm of energy for two strikes in three locations (six total strikes).

4. A Slim Line Tactical Fiber Optic Cable in claim 1, wherein that cable meets certain aspects of the Mil-Spec standards for fiber optic cables.

5. A Slim Line Tactical Fiber Optic Cable in claim 1, wherein the cable is produced using a pressure tooling extrusion process to ensure that the extrudate bonds to the acrylate coating of the optical fiber as tight buffer defined in GR-409. The buffered optical fiber is then embedded in a commercially available aramid yarn, which in addition is then passed through a pressure tooling extrusion process to apply a commercially available thermoplastic polyurethane (TPU) cable jacket.

6. The method, as claimed in claim 5, wherein the production process may yield a Slim Line Tactical Fiber Optic Cable within a 400 um to 750 um buffer range.

7. A Slim Line Tactical Fiber Optic Cable production method in claim 5, wherein the cable may be produced with a multi color buffer as needed.

8. A Slim Line Tactical Fiber Optic Cable production method in claim 5, wherein the cable may be produced with pressure tooled application of the extrudate.
